(19) United States
(12) Patent Application Publication
(10) Pub. No.: US 2005/0019144 A1
(43) Pub. Date: Jan. 27, 2005

(54) Forklift accessory for roll retrieval

(76) Inventor: Mark Neria, Santa Fe Springs, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/627,012

(22) Filed: Jul. 25, 2003

(51) Int. Cl. B66F 1/00

(52) U.S. Cl. 414/607

(57) ABSTRACT

The present invention relates generally to an accessory for a forklift truck that enables the truck to easily retrieve and move rolled goods, such as carpets, linoleum, and other materials commonly transported and/or sold in rolls. The essential features of the invention include a removable pole, and a pair of pallet-like rectangular tubes for receiving the forks of a forklift truck. The device is compact, sturdy, and capable of accommodating a range of pole lengths.

### BACKGROUND OF THE INVENTION

1. Field of the Invention

The present invention relates generally to an accessory for a forklift truck that enables the truck to easily retrieve and move rolled goods, such as carpets, linoleum, and other materials commonly transported and/or sold in rolls.

A common method for loading and moving such rolled goods is with the aid of a large pole. The pole, which can weigh well in excess of 100 pounds, is manhandled into place, and attached to the front mast of a forklift truck. The forks have to be removed in advance of this operation. When it is desirable to return the truck to forklift operation, the heavy pole must be removed, and the forks reattached.

This procedure is so onerous and manpower intensive that large operations dealing with rolled goods will actually dedicate a small truck to rolled goods service. Such a truck would equate to a forklift truck with forks permanently removed, and a pole permanently installed in place of the forks.

However, many establishments cannot afford to have a truck dedicated to rolled goods service. This includes not only small outfits, but also larger firms that only have rolled goods as a small part of their product line.

There is a need in the industry to adapt small trucks to easily and reliably switch between forklift (pallet) service and rolled goods (pole) service.

2. Description of the Related Art

Harris, in U.S. Pat. No. 3,705,658 describes an attachment to a forklift that resembles a pallet with a pole attached to one end. The forklift truck inserts the forks at the other end of the device, and can lift both the attachment device, and any rolled goods picked up by the pole. The device is longer that the length of a fork, so that a fork cannot protrude and potentially damage a roll. However, this dramatically increases the turning radius of the forklift truck, which creates a problem in many warehouses with limited travel space.

Smith, in US 2002/110,046 published patent application describes another attachment for moving rolled goods. The described device looks like a pair of parallel triangles, each with apex pointing upward. The triangles are connected at their base by a pair of hollow rails, which act as holder rails for the forks of a forklift. A beam that extends to a pole connects the apexes. This device functions much as the one above, and suffers the same problem of a large turning radius.

A competitive device not known to be patented is the Fork Mounted Rug pole, sold by R&R Loopers, Inc. online at http://www.rrloopers.com/. This device looks like a capital A frame, with rails extending perpendicularly out from the legs of the A, and a pole extending out on the same side from the apex. This device operates as the two above, although this device differs in that the forks extend outward directly below the pole. This results in a much lower turning radius compared to the devices above. However, durability is a concern, because having the rails on the same side as the weighty rolled goods puts a strain on the frame not found in the earlier devices, in which the rails tend to counterbalance the weight of the rolled goods.

### SUMMARY OF THE INVENTION

The present invention relates generally to a device that is used to augment a standard forklift truck in service of moving carpet or other rolled goods.

The invention further relates a pole, mounted on a pallet-like platform, which can be engaged and lifted by the forks of a forklift truck, and thereafter used to aid in the movement of rolled goods.

### BRIEF DESCRIPTION OF THE DRAWINGS

FIG. 1 Shows the preferred embodiment of the present invention from a frontal perspective view

FIG. 2 Shows the present invention 100 from a front view

FIG. 3 Shows a top view of the present invention 100

FIG. 4 Side gussets 9 of the present invention 100

FIG. 5 Front stabilizer plate 17 of the present invention 100

FIG. 6 Vertical support bar 15 of the present invention

FIG. 7 Shows a lower gusset 7 for the pole support 11.

FIG. 8 Shows detail of the pole support tube 11

FIG. 9 Shows the bolt 19 for holding forks into fork receptacles 3

FIG. 10 Side view of rear stabilizer bar 13

FIG. 11 Perspective view of fork receiver 3

FIG. 12 Detail of pole 1

FIG. 13 Alternate embodiment from a perspective view

### DESCRIPTION OF THE PREFERRED EMBODIMENTS

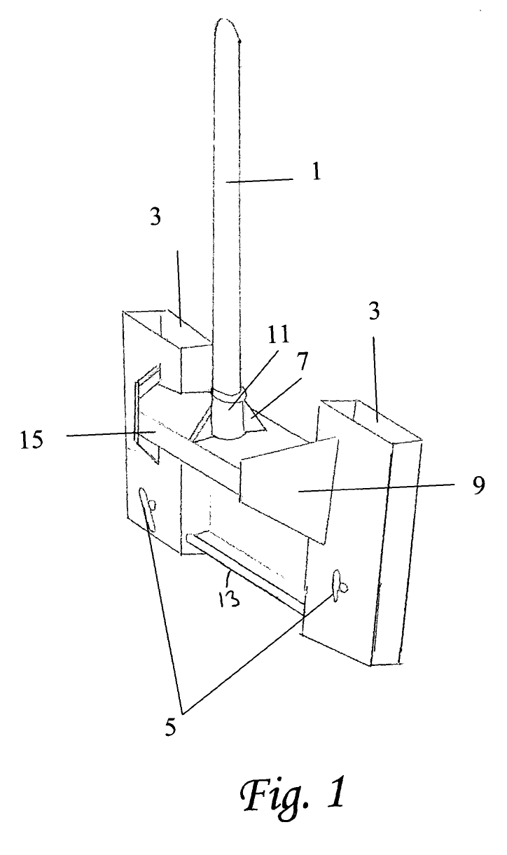

In FIG. 1, the present invention 100 is displayed from an inverted perspective view, ie from below and in front. This is an excellent view that shows the majority of the features of the present invention.

The heart of the invention is the pole 1. Constructed of preferably 3 inch OD solid steel, and available in various lengths (12 feet is a common length), the pole is used to pick up rolls of carpet, linoleum, or other rolled goods via insertion into the central hole of the roll. The roll can thus be lifted and transported via forklift truck to a desired location, and thereafter easily removed off the pole.

The other central feature of the present invention is the pair of fork receivers 3. Also known as rails, these are ideally 28 inches in length, 6 inches in width, and 3 inches in height, and constructed of preferably rectangular steel tubing, approximately 3/16 inches in thickness. These are used to accept and hold the forks of a forklift truck. In a preferred embodiment, a driver will drive up to the rear of the invention (side opposite the pole), and insert the forks into the fork receivers, much as he would to a normal wooden pallet.

Once the forks are inserted, the lock handles 5 are tightened via turning. This locks the forks in place, so that the present invention remains stably attached to the forklift truck during operation. When the operation of moving rolled goods is complete, the truck can be returned to normal forklift service simply by unlocking the lock handles 5, and backing up the forklift truck to disengage the forks from the fork receivers 3.

The other features of the present invention 100 are support devices and devices to improve flexibility. The pole 1 is supported by pole support 11, which in turn is supported by side gussets 7. Pole support 11 is attached to a vertical support 15 by means of a threaded bolt 19, shown in FIG. 9. Vertical support 15 is supported by side gussets 9, and attached to fork receivers 3.

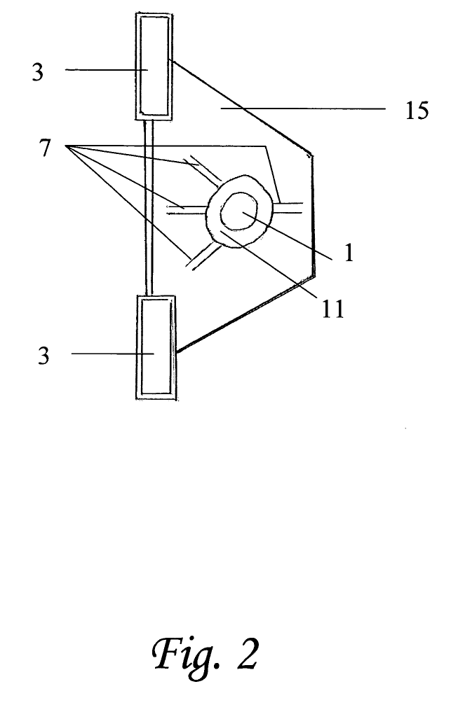

FIG. 2 shows the present invention from a frontal view. From this view the invention has a flattened triangular cross-section, with the flattened base at the bottom of the vertical support 15, tapering up and outwardly to the apex, at either end of which is found the fork receivers 3. The round pole support 11 can be seen encircling pole 1, and the side gussets 7 are clearly shown. The flattened top of the vertical support is ideally 9 inches in width. The vertical support is preferably 11 inches in height, from the base to the top of the fork receivers 3.

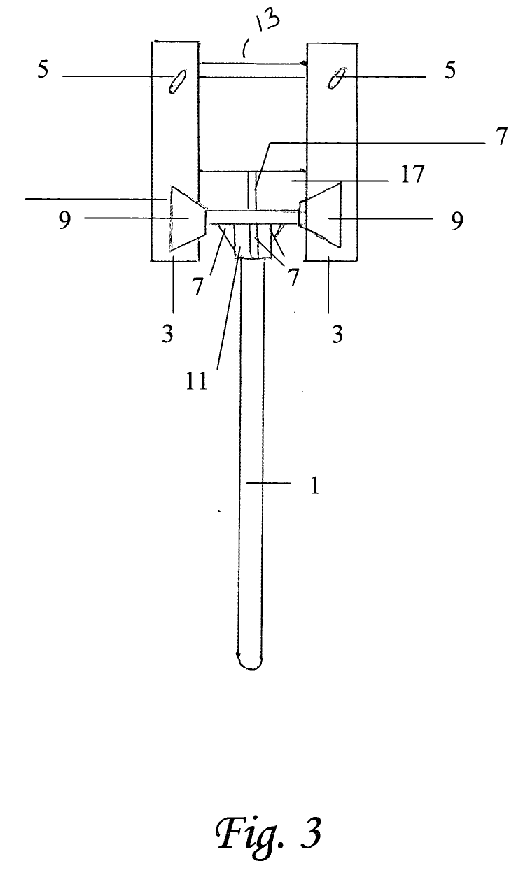

FIG. 3 shows a bottom view of the present invention. In addition to the items shown in FIG. 1, the front stabilizer plate 17 can be seen in this view, directly underneath vertical support 15, and connecting the pair of fork receivers 3. Also in this view is seen rear stabilizer bar 13. This bar also runs between the pair of fork receivers 3, parallel to 17, but near the back of the invention.

FIG. 3 also illustrates the fact that the fork receivers 3 are parallel to each other, and the front faces (pole side) of each are flush with respect to each other and to the leading edge of pole support 11. At the same time, vertical base 15 and its side gussets 9 are disposed behind the plane defined by the front edges of the fork receivers 3. In this manner, rolled goods can be fitted flush to the fork receivers, without interference from other components of the present invention. This saves space, which is often at a premium in warehouses, and reduces the turning radius of the forklift truck when engaged with the present invention.

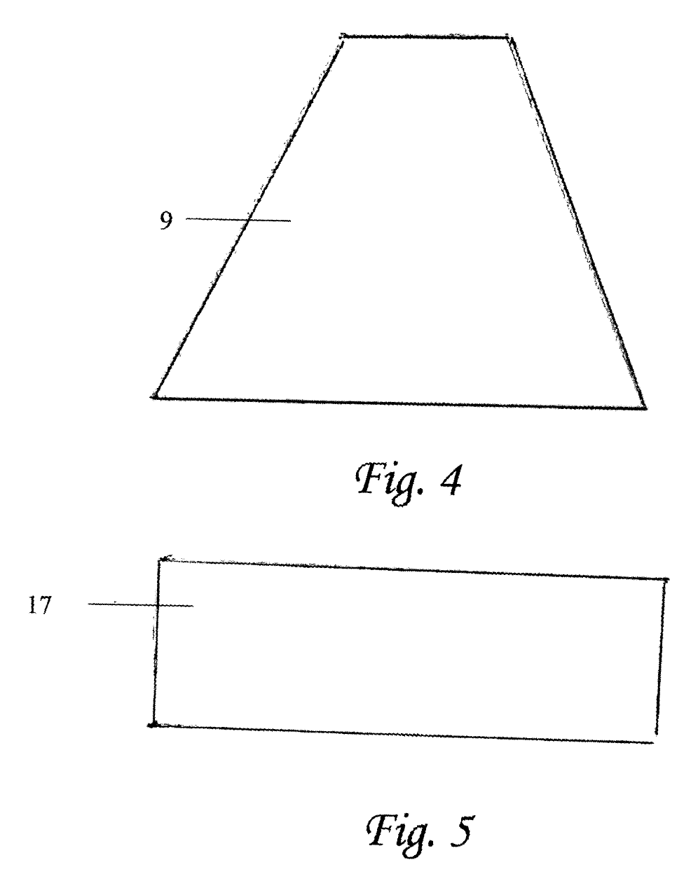

In FIG. 4, a side gusset 9 is shown. This has a flattened triangular shape in cross-section, with the top about 3¼ inches wide, the entire gusset 8 inches tall, and 12 inches wide at the base. The two side gussets are constructed of preferably ½ inch thick steel.

FIG. 5 shows the front stabilizer plate 17. This is a simple rectangle, 15 inches long by 7 inches wide, and constructed of preferably ½ inch thick steel.

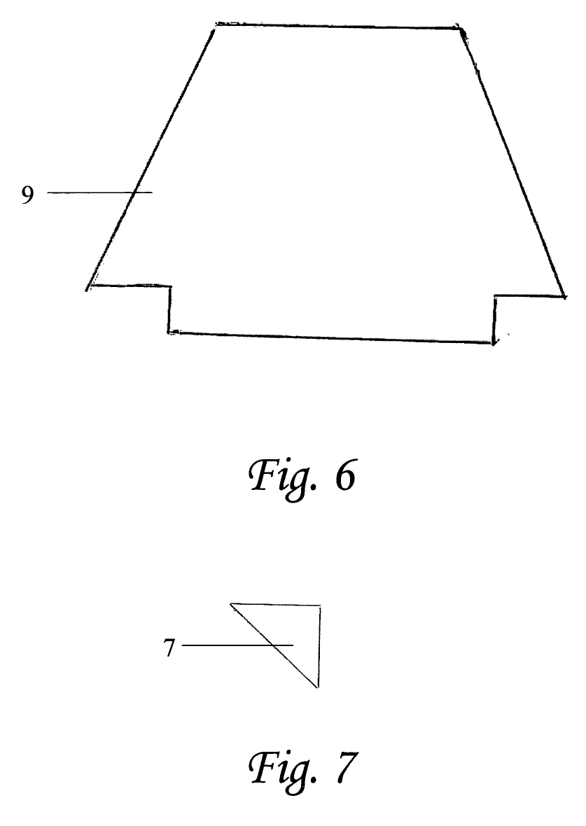

FIG. 6 shows the vertical support plate 15 alone. It is also of a flattened triangular shape in cross-section, with the top about 9 inches wide, the entire base 13 inches tall, and nominally a full 21 inches wide at the base. However, the base has cutouts to fit the fork receivers 3. These cutouts, at either end of the base, are 2 inches in height, and 3 inches in width. Thus, the width of the plate 15 at its base is only 15 inches between the two cutouts.

FIG. 7 shows a side gusset for the pole support. This gusset is preferably shaped in the form of a right triangle, with the two sides connected at the 90° angle each being 5 inches long. The gussets are constructed of preferably ½ inch thick steel.

FIG. 7 also shows the shape of the rear gusset 21 for the pole support. This gusset again is preferably shaped in the form of a right triangle, with the two sides connected at the 90° angle each being 7 inches long, thus somewhat larger than side gussets 7. The gusset 21 is constructed of preferably ½ inch thick steel.

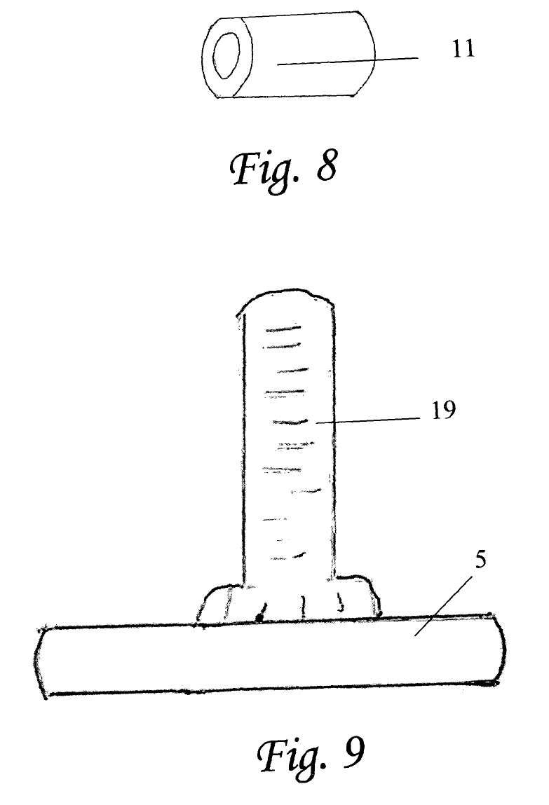

FIG. 8 is a close-up view of pole support collar 11. This collar is ideally 5 inches long, and about 5 inches in outer diameter, hollowed out to support the pole 1. The inner diameter of 11 is thus 3 inches, to provide a tight fit with the pole. Optionally, a locking pin can be attached, to secure the pole stably within the collar.

FIG. 9 shows the bolt that comprises the fastening component of lock handles 5. The bolt is preferably ¾ inch number 10 bolt, 3 inches long, and is welded at its head to a lock handle 5. When handle 5 is turned, the bolt screws into a fork placed within the fork receiver.

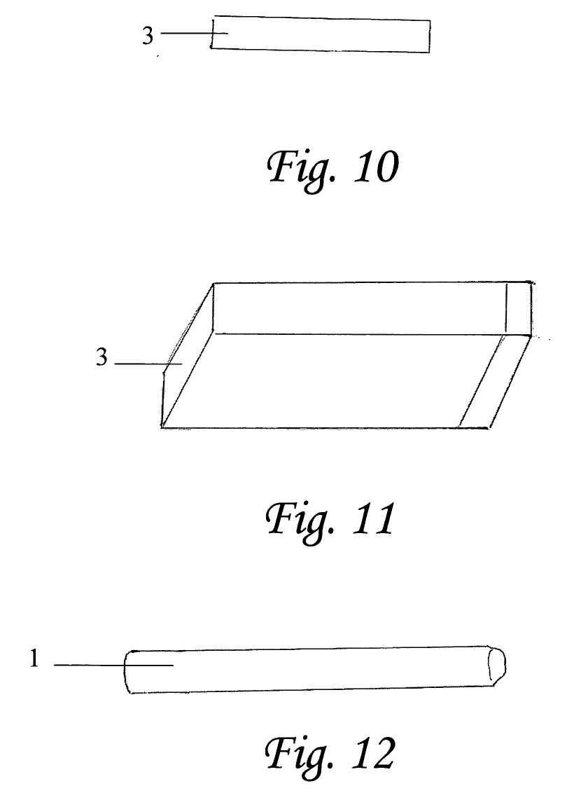

FIGS. 10-12 show details of a fork receiver 3 from two views, and the pole 1. In FIG. 10, the end view of a fork receiver 3 indicates its construction of tubular steel. Notably in FIG. 11, each fork receiver 3 is wrapped at either end with ⅜ inch by 1 1/2 inch strapping. The strapping improves visibility, thus adding to safety of the device. FIG. 12 again indicates the solid steel construction of pole 1.

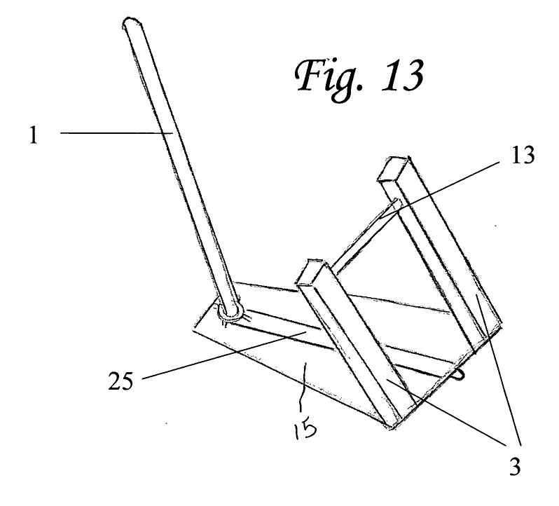

FIG. 13 displays an alternate embodiment of the present invention. In this view, the invention is shown tilted on its side. In this embodiment, the vertical distance from pole 1 to fork receivers 3 is 21 inches—almost double the 11 inches of the first embodiment. This increased vertical displacement of the pole allows the fork receivers 3 to extend in front of vertical support plate 15 in the same direction of the pole, instead of substantially on the opposite side of 15, as is found in the first embodiment in FIGS. 1-3. Note the stiffening support rod 30 on the face of the vertical support plate opposite the pole. This is intended to help offset the weight distribution in this embodiment.

Both embodiments have advantages, each over the other. The preferred embodiment has the weight of the forks and receivers counterbalancing the weight of the rolled goods on the pole. This allows for more durability than the alternate embodiment of FIG. 13. However, the alternate embodiment of FIG. 13 does allow for reduced turning radius, as the pole and rolled goods extend not as far out from the forklift truck as in the preferred embodiment.

While the present invention has been described in terms of several preferred embodiments, it is not intended to limit the invention to the particular forms set forth. On the contrary, the present invention is intended to cover such alternatives, alterations, modifications, and equivalent structures and devices as may be included within the spirit and scope of the invention as defined within the appended claims.

1. A device for attaching to a forklift truck, and thereby aiding in the movement and transport of rolled goods, said device comprising:
a pair of rectangular tubes, suitably disposed for the reception of the forks of a forklift truck,
a vertical support plate, arising above and between said tubes, and substantially perpendicular to said tubes;
a pole, extending outward from one face of said vertical support plate, said vertical support plate connecting said tubes to said pole, and,
a plurality of base plates between said tubes, stably connecting each tube to the other.

2. The device of claim 1, further comprising side gussets to support said pole and said vertical support plate.

3. The device of claim 1, further comprising a plurality of locking devices to ensure that the forks of a forklift truck do not disengage from said tubes during operations.

4. The device of claim 1, further comprising a support collar for securing said pole stably to said vertical support plate.

5. The device of claim 1, further comprising a means for replaceably removing said pole.

6. The device of claim 4, wherein the means for securing said pole comprises a latching pin securing said pole to said support collar.

7. The device of claim 1, wherein the fork receiving tubes are each at least 28 inches long.

8. The device of claim 1, wherein the fork receiving tubes are substantially parallel, and substantially flush with the leading edge of the device with pole removed.

9. The device of claim 1, wherein the vertical support plate is at least 13 inches in height.

10. The device of claim 1, wherein the length of the pole is sufficient for a standard commercial roll of rolled goods to be inserted thereupon, with no length of rolled goods left hanging over the free end of the pole.

11. The device of claim 1, wherein the fork receivers extend entirely outward from the vertical support plate, on the same side thereon as the pole.

12. The use of the device of claim 1 in connection with a forklift truck to engage and move rolled goods.
